(19) United States
(12) Patent Application Publication
(10) Pub. No.: US 2006/0072046 A1
(43) Pub. Date: Apr. 6, 2006

(54) [LIQUID CRYSTAL DISPLAY WITH REPLACEABLE MEDIA PLAYER]

(75) Inventor: Hung-Chang Tseng, TAIPEI (TW)

Correspondence Address: BATON DIGITAL ELECTRONIC TECH. CO., LTD., P. O. BOX 108-00403, TAIPEI, TW

(73) Assignee: BATON DIGITAL ELECTRONIC TECH. CO., LTD., CHUNG-HO CITY (TW)

(21) Appl. No.: 10/711,776

(22) Filed: Oct. 4, 2004

(51) Int. Cl. G02F 1/1335

(52) U.S. Cl. 349/16

(57) ABSTRACT

A liquid crystal display (LCD) device, suitable for a vehicle is disclosed. The LCD device comprises a chassis comprising a display; a plurality of control buttons, disposed on one side surface of the chassis; and a receiving space, for receiving a media player, comprising a connecting port on another side of the chassis for electrically connecting with a connector of the media player so that the LCD is capable of receiving and electrically connecting with different media players and play data stored therein without any extra space occupation.

### BACKGROUND OF THE INVENTION

1. The Field of the Invention

The present invention relates an liquid crystal display (LCD) device with replaceable media player, and more particularly to an LCD device suitable for a vehicle capable of receiving and electrically connecting with different media players to provide convenience and better entertainment to the users.

2. Description of Related Art

Rapid advancement of technology has developed multi-functional LCD TV from a computer display and TV set. This outstanding development is leading digital revolution of the next decade, allowing the users to replace their analogue TV set into the digital TV or LCD TV. Possibly, by the year 2006, which is predicted as a turning point for digital TV, about 1-1.6 million TV sets could be replaced by the end of the year 2005.

LCD has several advantages, such as finer resolution, lower radiation, non electromagnetic wave, smaller space occupation, less power consumption and so on, and therefore is a very attractive product on the market. Nowadays most of the latest transportation vehicles, for example, car, bus and RV are equipped with LCD device to coordinate with the media player to enjoy entertainments while traveling. Presently, a car LCD coordinates with only one type of media player, for example, VCD or DVD and the users have no other choice. However, the latest technology has developed many different types of media player that the users can enjoy, such as, card reader, MP3 player and the like. Furthermore, many software producers are continuously developing new game players along with the new game software to satisfy the users' need. The recent production of the game software is more exquisite and various. Accordingly, it would be of great pleasure for the users if such entertainment can be applied in the car. However, to install such media players in the car would substantially occupy considerable space making the space within the car more compact and uncomfortable to passengers.

Therefore, it would be highly desirable if different media players can be connected to the LCD without sacrificing much space within the car, which is an important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a new LCD device capable of receiving and electrically connecting with different media players and play data stored therein so that extra space occupation can be effectively reduced.

According to an aspect of the present invention, the LCD device suitable for a vehicle is capable of receiving and electrically connecting with different media players so that the user can selectively insert a media player with a desired data stored therein and enjoy listening/watching the desired data while traveling. Furthermore, space required for installing different entertainment devices inside the car can be effectively reduced. Furthermore, the media player can be removed from the LCD device while the vehicle is parked in a public parking area in order to prevent burglary.

### BRIEF DESCRIPTION OF THE DRAWINS

For a more complete understanding of the present invention, reference will now be made to the following detailed description of preferred embodiments taken in conjunction with the following accompanying drawings.

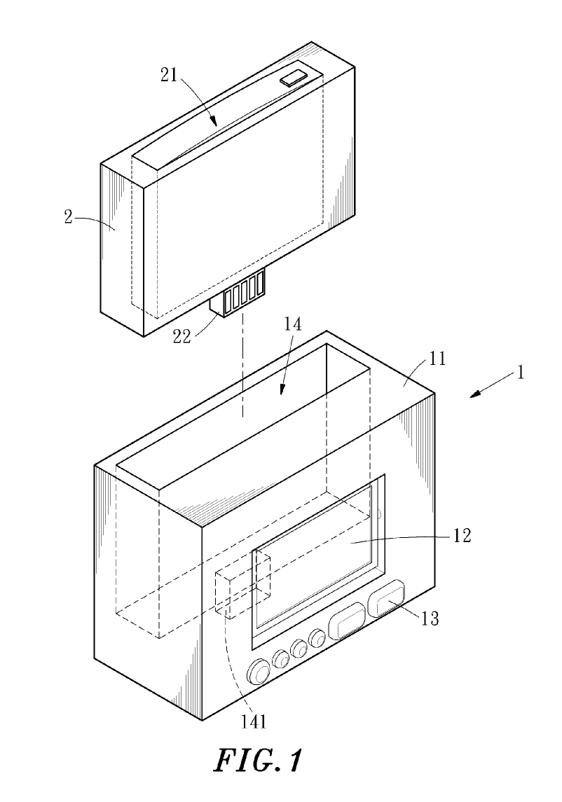

FIG. 1 is an exploded view showing an LCD device with replaceable media player according to an embodiment of the present invention.

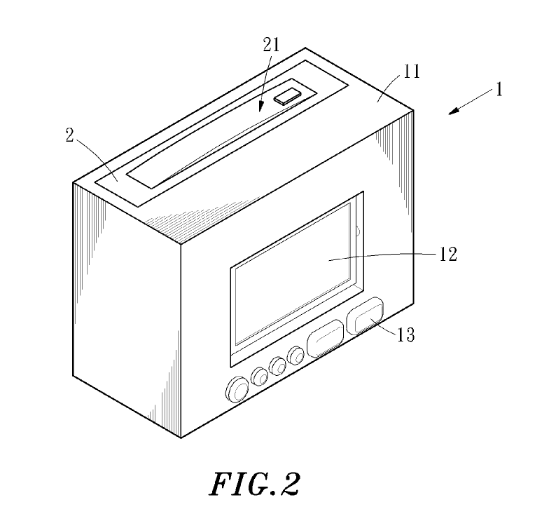

FIG. 2 is an elevational view showing an LCD device with replaceable media according to an embodiment of the present invention.

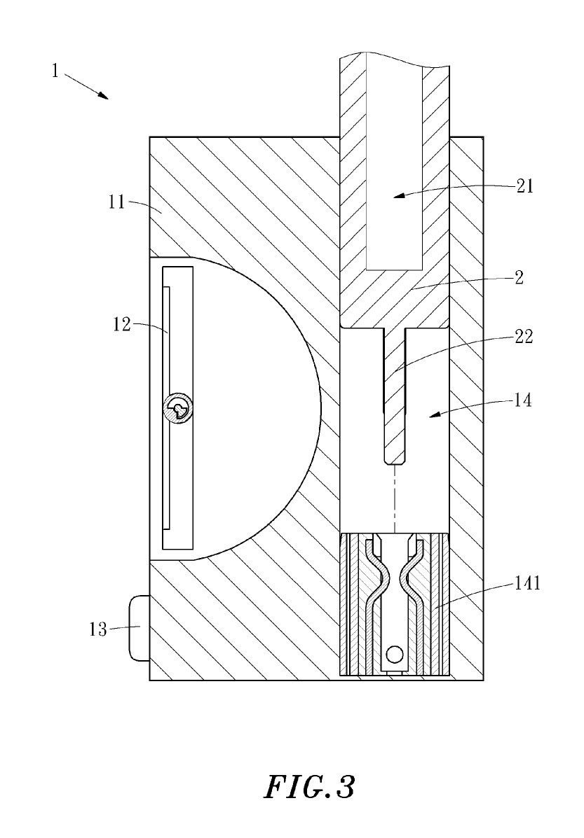

FIG. 3 is a sectional side view of the LCD device with replaceable media according to an embodiment of the present invention.

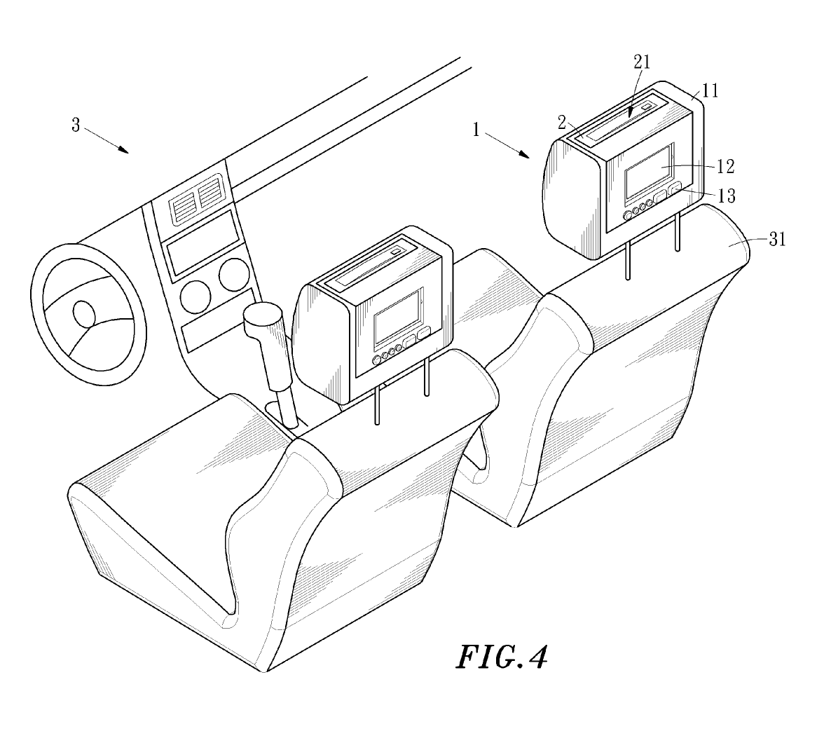

FIG. 4 is an elevational view showing an LCD device with replaceable media according to another embodiment of the present invention.

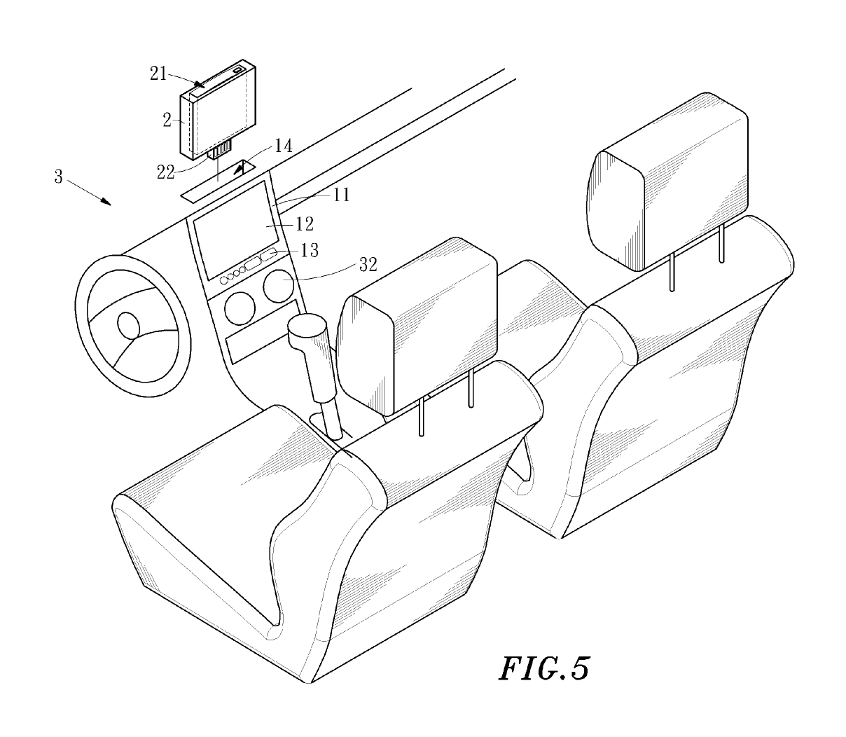

FIG. 5 is an elevational view showing an LCD device with replaceable media according to another embodiment of the present invention.

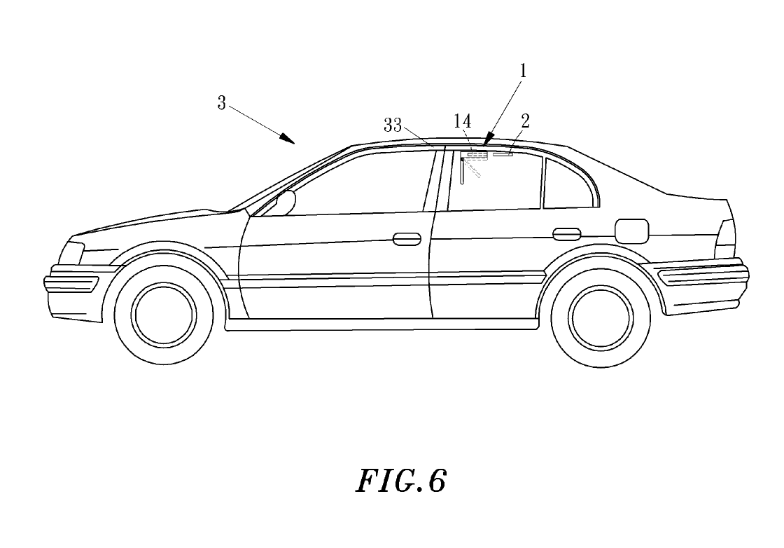

FIG. 6 is an elevational view showing an LCD device with replaceable media according to another embodiment of the present invention.

### DETAILED DESCRIPTION OF EMBODIMENT

Reference will be made in detail to the preferred embodiments of the invention, examples of which are illustrated in the accompanying drawings. Wherever possible, the same reference numbers are used in the drawings and the description to refer to the same or like parts.

Referring to FIG. 1, an exploded view of a LCD device with replaceable media player comprising a LCD device 1 and a media player 2 according an embodiment of the present invention is shown.

The LCD device 1 comprises a chassis 11 having a display 12. A plurality of control buttons 13 disposed on one side surface of the chassis 11 and a receiving space 14 having a connecting port 141 disposed at another side thereof.

The media player 2 comprises a chamber 21 for fitting a media at an upper portion thereof and a connector 22 is at a lower portion thereof.

Referring to FIGS. 1, 2 and 3, an exploded view, an elevational view and a sectional side view of the LCD device with replaceable media player according to an embodiment of the present invention are shown. According to an embodiment of the present invention, the media player 2 is inserted into the receiving space 14 of the LCD device 1 such that the connecting port 141 within the receiving space 14 electrically connects the connector 22 of the media player 2. Thus, the data stored in the media player 2 can be played via the display 12 of the LCD device 1. The media player 2 can be removed from the receiving space 14 and another media player 2 can be inserted into the receiving space 14 for playing the data stored therein via the display 12 of the LCD device 1. Thus, the media player 2 can be easily replaced with another media player 2 allowing the user to enjoy watching/listening to the desired data stored in the various media players 2. According, the system of the present invention is capable of providing great entertainment to the user.

The above media player 2 can be a read-only-memory (ROM), a card reader, a game player, an MP3 player and a DVD player.

Referring to FIG. 4, an elevation view illustrating the operation of the LCD device with replaceable media player according to an embodiment of the present invention is shown. In the present embodiment, the LCD device with replaceable media player is installed on a seat 31 of a vehicle 3 so that the system does not occupy any extra space. The media player 2 can be removed from the receiving space 14 while the vehicle 3 is parked in a public parking area to prevent burglary thereof.

Furthermore, the system of the present invention can also be installed in the front side 32 inside the vehicle 3 as shown in FIG. 5 or in an inner top surface 33 of the vehicle 3 as shown in FIG. 6. The system of the present invention can be installed in various vehicles 3.

Accordingly, the LCD device with replaceable media player of the present invention is capable of receiving and electrically connecting different media players, and the inserted media player can be effectively protected therein. The connector of the media player can be electrically connected with the connecting port in the receiving space so that the data stored in the media player can be transmitted via the connecting port to the LCD device for displaying and playing the data.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A liquid crystal display (LCD) device, suitable for a vehicle, the LCD device capable of receiving and electrically connecting a replaceable media player, the LCD device comprising:
a chassis, comprising a display;
a plurality of control buttons, disposed on one side surface of the chassis; and
a receiving space, for receiving a media player, comprising a connecting port on another side of the chassis for electrically connecting with a connector of the media player so that the LCD device is capable of receiving and electrically connecting different media players and playing data stored therein without any extra space occupation.

2. The LCD device according to claim 1, wherein the media player is a ROM.

3. The LCD device according to claim 1, wherein the media player is a card reader.

4. The LCD device according to claim 1, wherein the media player is a game player.

5. The LCD device according to claim 1, wherein the LCD device is installed in a front side inside the vehicle.

6. The LCD device according to claim 1, wherein the LCD device is installed on a seat of the vehicle.

7. The LCD device according to claim 1, wherein the LCD device is installed in an inner top surface of the vehicle.
